(19) United States
(12) Patent Application Publication
(10) Pub. No.: US 2008/0290161 A1
(43) Pub. Date: Nov. 27, 2008

(54) METHOD OF SECURE TRANSMISSION

(75) Inventor: Christopher Ian Blake, West Ryde (AU)

Correspondence Address: BARNES & THORNBURG LLP, 11 SOUTH MERIDIAN, INDIANAPOLIS, IN, 46204, US

(73) Assignee: BQT SOLUTIONS (AUSTRALIA) PTY LTD, North Ryde (AU)

(21) Appl. No.: 12/186,559

(22) Filed: Aug. 6, 2008

Related U.S. Application Data
(63) Continuation of application No. 10/522,067, filed on Oct. 4, 2005.

(30) Foreign Application Priority Data
Jul. 24, 2002 (AU) PCT/AU02/00984

(51) Int. Cl. G06K 5/00

(52) U.S. Cl. 235/382

(57) ABSTRACT

A method, a system, and an apparatus for proving secure transmissions from a smartcard reader are described. A signal created by the smartcard reader dependent on the smartcard is encrypted. The signal comprises access information. The encrypted signal is transmitted to a remote location relative to the smartcard reader. The transmitted signal is translated at the remote location to another format useable by an access controller. An access mechanism is controlled using the access controller dependent upon the translated signal.

### FIELD OF THE INVENTION

The present invention relates generally to security systems and in particular to secure transmission systems and security systems utilising biometric sensors.

### BACKGROUND

Existing security systems are of several different types. One type of security system utilises a smartcard as a key for access to a secure location or secure equipment. The smartcard contains security information providing access via a smartcard reader at the access point. A user presents the reader with the smartcard. If the smartcard is authorised, the reader actuates a control mechanism to provide access. Thus, for example, the reader may signal a controller that controls operation of a latch mechanism controlling access to a door or provide access to a computer terminal. One example of a relevant reader that may be used in such a system is a Wiegand reader. One significant disadvantage of such systems is that the smartcard if stolen or otherwise in the possession of an unauthorised person may allow the unauthorised person to access the secure location or equipment.

Another security system utilises a biometric sensor to control access. A user must provide biometric data, normally a fingerprint, speech, or an eye scan via a sensor at the access point. Other forms of biometric data include facial details and hand geometry. Biometrics is a physical characteristic of a person used as a form of identification. The biometrics data is used in place of, or in addition to a security key, such as a key, card or PIN. A database or central repository of stored biometric data is maintained in a computer, with which the sensor can communicate. The scanned biometric data is compared with the stored biometric data, and if a match is found the user is permitted access. This system is generally more secure than that of the smartcard system, but is disadvantageous in that a central repository of biometric data must be maintained and updated. Further, significant time may be required to conduct such a comparison of the scanned biometric data against the database or central repository to determine whether or not there is a match.

Conventional systems are also disadvantageous in that the products' sizes are bulky. Still a further disadvantage of conventional systems is that such products cannot protect against security breaches arising from a person getting into security lines in a wall to which the reader is connected and providing false authorization signals and the like to a controller.

### SUMMARY

In accordance with an aspect of the invention, there is provided a method of providing secure transmissions from a smartcard reader. The method comprises the steps of: encrypting a signal created by the smartcard reader dependent on the smartcard, the signal comprising access information; transmitting the encrypted signal to a remote location relative to the smartcard reader; translating at the remote location the transmitted signal to another format useable by an access controller; and controlling an access mechanism using the access controller dependent upon the translated signal.

The smartcard may contain biometric data and the smartcard reader may comprise a biometric smartcard reader for obtaining biometric data directly. The biometric data may comprise fingerprint data. The biometric data is not transmitted to the remote location from the smartcard reader.

The method may further comprise the step of providing access using the access mechanism if the translated signal is determined by the access controller to authorise access. The access mechanism is able to provide access to at least one of a door, portal, computer, network, secure equipment and secure installation. The access information may comprise at least one of a person's name, a facility code, a company code, an access code, and an issue code. The signal may be encrypted using triple DES, Skipjack, or AES Rijndael encryption.

The method may further comprise the step of encrypting communications between the smartcard and the smartcard reader. The encrypted signal may be transmitted from the smartcard reader to a high security module at the remote location. The high security module translates the encrypted signal to the other format.

The smartcard reader and the high security module may be separated by a distance of up to 1.2 kilometres. Alternatively, the smartcard reader and the high security module are separated by a distance of up to 15 metres.

The translated signal may be in a controller-specified format. Preferably, the controller-specified format is Wiegand format, or clock and data.

In accordance with another aspect of the invention, there is provided a system for providing secure transmissions from a smartcard reader. The system comprises: a smartcard reader for encrypting a signal created by the smartcard reader dependent on the smartcard, the signal comprising access information, and for transmitting the encrypted signal to a remote location relative to the smartcard reader; a high security module for receiving the transmitted signal and translating the transmitted signal to another format useable by an access controller; and an access controller for controlling an access mechanism using the access controller dependent upon the translated signal.

The smartcard may contain biometric data, and the smartcard reader may comprise a biometric smartcard reader for obtaining biometric data directly. The biometric data may comprise fingerprint data. The biometric data is not transmitted to the high security module from the smartcard reader.

The system may further comprise an access mechanism providing access if the translated signal is determined by the access controller to authorise access. The access mechanism may be able to provide access to at least one of a door, portal, computer, network, secure equipment and secure installation. The access information may comprise at least one of a person's name, a facility code, a company code, an access code, and an issue code.

The signal is encrypted using triple DES, Skipjack, or AES Rijndael encryption. Communications between the smartcard and the smartcard reader may be encrypted. The smartcard reader and the high security module may be separated by a distance of up to 1.2 kilometres. Alternatively, the smartcard reader and the high security module may be separated by a distance of up to 15 metres.

The translated signal may be in a controller-specified format. The controller-specified format may be Wiegand format, or clock and data.

In accordance with still another aspect of the invention, there is provided an apparatus for providing secure transmissions from a smartcard reader. The apparatus comprises: a smartcard reader for encrypting a signal created by the smartcard reader dependent on the smartcard, the signal comprising access information; a module for transmitting the encrypted signal to a remote location relative to the smartcard reader; a module for translating at the remote location the transmitted signal to another format useable by an access controller; and an access controller for controlling an access mechanism dependent upon the translated signal.

The smartcard may contain biometric data and the smartcard reader may comprise a biometric smartcard reader for obtaining biometric data directly. The biometric data may comprise fingerprint data.

In accordance with a further aspect of the invention, identification using of biometric data is disclosed. A smartcard encoded with biometric data is read. Actual biometric data is sensed. The biometric data from the smartcard is then compared with the sensed biometric data for verification. Access may be allowed if the biometric data from the smartcard and the sensed biometric data match. This may involve verifying that the biometric data encoded on the smartcard is correct. The biometric data stored in the smartcard is derived by scanning a source of biometric data associated with the smartcard, encoding the scanned biometric data, and storing the encoded biometric data on the smartcard. The biometric data may include a fingerprint. Optionally, a detail level can be specified for scanning the biometric data.

### BRIEF DESCRIPTION OF THE DRAWINGS

A small number of embodiments are described hereinafter with reference to the drawings, in which:

FIG. 1 is a high-level flow diagram illustrating an enrollment operation of a biometric smartcard system including a biometric smartcard reader or encoder in accordance with an embodiment of the invention;

FIG. 2 is a flow diagram illustrating a process of enrolling a fingerprint on a smartcard using a biometric smartcard encoder, providing further details of the embodiment of FIG. 1;

FIG. 3 is a flow diagram illustrating a process of verifying a finger on the biometric smartcard encoder, providing further details of the embodiment of FIG. 1;

FIG. 4A is a block diagram illustrating the structure of storage or memory in a smartcard in accordance with the embodiment of the invention;

FIG. 4B is a table illustrating an arrangement of security keys used in the smartcard of FIG. 4A in accordance with the embodiment of the invention;

FIG. 5 is a functional block diagram showing modules of a biometric smartcard reader or encoder in accordance with the embodiment of the invention;

FIG. 6 is a perspective view of a biometric smartcard reader or encoder in accordance with the embodiment of the invention shown in FIG. 5;

FIG. 7 is a block diagram of a secure transmission system in accordance with a further embodiment of the invention;

FIG. 8 is a flow diagram illustrating a process of secure transmission in accordance with the further embodiment of the invention, which may be practiced with the system of FIG. 7;

FIG. 9 is a block diagram of a secure transmission system in accordance with another embodiment of the invention;

FIG. 10 is a block diagram of a secure transmission system in accordance with still another embodiment of the invention; and

FIG. 11 is a flow diagram illustrating a process of providing secure transmissions from a smartcard reader in accordance with a further embodiment of the invention.

### DETAILED DESCRIPTION

A method, an apparatus, and a system for biometric smartcard reading and encoding, as well as for secure transmissions are described hereinafter. Numerous specific details are set forth. However, it will be apparent to those skilled in the art in the light of this disclosure that various modifications may be made without departing from the scope and spirit of the invention. Embodiments of the invention provide equipment that synthesise biometric and smartcard technologies to provide a smartcard reader or encoder that eliminates central database communications infrastructure. As the smartcard holds the biometric information, the requirement of central repositories of biometric data and associated security issues are obviated. A significant application of the reader or encoder is as an access control device at security point, whether for access via a door or other portal, or to a computer, network, or other secure equipment or installation.

In the following description, the terms biometric smartcard reader and biometric is smartcard encoder are used. A reader is a device that is able to scan a person's biometric data and contactlessly read a smartcard to obtain stored biometric data. The biometric data is preferably a fingerprint. The smartcard is presented to the reader (preferably, 10 mm to 40 mm away), and write/read operations are communicated from the reader to the smartcard. The reader then compares the scanned biometric data and stored biometric data to determine if there is a match. The reader may be located at an access point to provide access to a location or equipment in a security system dependent on the results of the comparison. An encoder is able to perform the functions of a reader including contactless communications with the smartcard, but also is able to encode a smartcard with personal details and biometric data. More particularly, the encoder preferably includes a logical access system where all access in a facility is controlled using a card, i.e. for doors, for PC access, etc. Such a smartcard access system by its nature almost ensures that the user does not forget to leave the smartcard behind. Preferably, an encoder has an appropriate interface to enable the encoder to be connected with a computer to enroll a person's details and biometric data on the smartcard using software running on the computer. The encoder stores biometric data in a two-dimensional structure or template and card holder details on the smartcard. The encoder may have an insert slot in the housing body to receive such a smartcard. The slot allows detection of the smartcard during an encoding process. A reader cannot be used for enrolment of biometric data and other associated information on a smartcard as can an encoder. For ease of description, the following text uses the two terms biometric smartcard reader and biometric smartcard encoder substantially interchangeably, but the noted distinctions should be borne in mind.

### Biometric Smartcard Reader or Encoder

In accordance with an embodiment of the invention, a biometric smartcard reader or encoder is disclosed. FIG. 5 is a block diagram illustrating a smartcard 540 and a biometric smartcard reader 500 in accordance with an embodiment of the invention. This biometric smartcard reader 500 is smaller than other biometric units. The biometric smartcard reader 500 includes a biometric sensor 510 coupled to a sensor control module or printed circuit board 520. The sensor PCB 520 contains modules for processing and encoding scanned biometric data into a suitable digital representation using a given coding algorithm (e.g., Sagem). The fingerprint is stored as a template preferably and not as a digital image. An algorithm is used to generate the template. For fingerprints, examples of relevant algorithms use minutiae reference points, or ridge recognition patterns, for example. In turn, the sensor PCB 520 is coupled to a smartcard reader PCB 530 and sends fingerprint data in a given template to the smartcard reader PCB 530, which is also able to interrogate and obtain data from a smartcard 540. This is preferably done by presenting the smartcard reader PCB 530 with the smartcard 540, in which the smartcard reader PCB 530 energises the smartcard 540 if in close proximity and communicates with the smartcard 540. Preferably, the smartcard reader PCB 530 is a contactless reader using a Philips Chip Mifare® utilising the Wiegand format for its output. Communication between the smartcard 540 and the smartcard reader PCB 530 is encrypted. The encryption utilised with his embodiment involves a proprietary encryption method of Mifare®, which is embedded in the Mifare® smartcards. Another option is to use DES encryption. However, it will be apparent to those skilled in the art in the light of this disclosure that other encryption techniques may be used without departing from the scope and spirit of the invention.

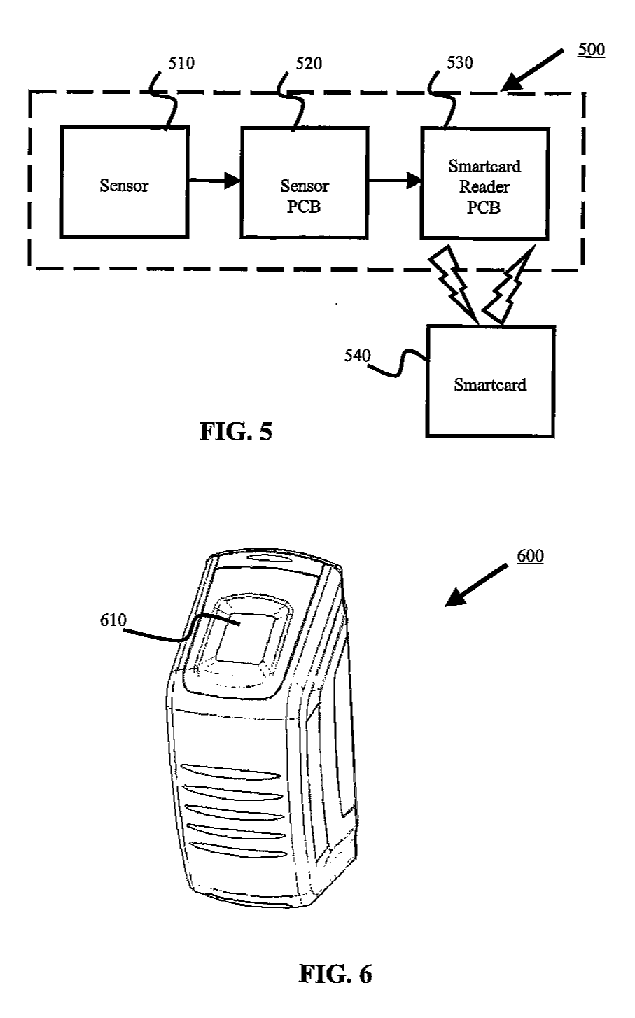

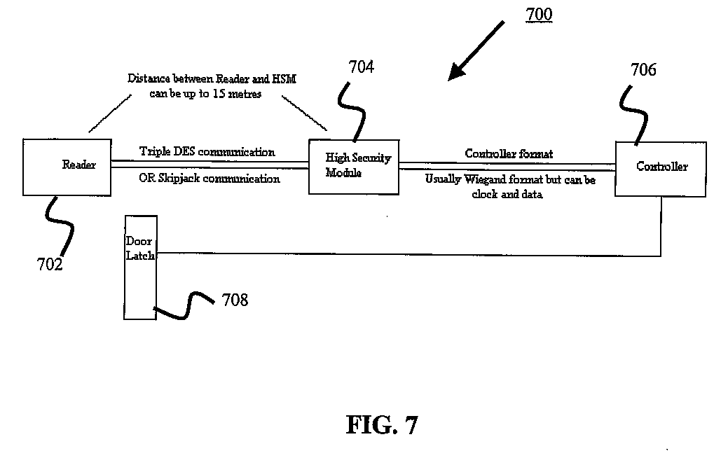

More preferably, the biometric smartcard reader 500 incorporates a biometric finger scan sensor 510 (e.g., for scanning fingerprints) with an accompanying sensor PCB 520. The fingerprint sensor technology may be optical, capacitive, thermal, tactile, or a combination of the foregoing. An example of a sensor arrangement that may be used is a Bioscrypt product provided by Bioscrypt Inc. including an Authentic sensor, a Bioscrypt PCB, and Bioscrypt's own encoding algorithm. Alternatively, the sensor arrangement may be implemented using an ST sensor, a Yuean PCB provided by Yuean Biometrics, and the Sagem algorithm, or a SecuGan product provided by SecuGen Corporation including a SecuGen sensor, a SecuGen PCB, and the SecuGen algorithm. Still further, a SecuGen optical solution may be practiced that enables a rugged and robust design. However, it will be apparent to those skilled in the art in the light of this disclosure that other biometric sensors may be practiced without departing from the scope and spirit of the invention. The sensor 510 and associated PCB 520 scan a person's fingerprint and generate a digital representation of that fingerprint as digital biometric data. FIG. 6 is a perspective view of a biometric smartcard reader 600, which embodies the reader 500 of FIG. 5 including a biometric sensor 610/510, an associated sensor PCB 520 (not shown), and a Mifare® smartcard reader PCB 530 (not shown) in a single unit.

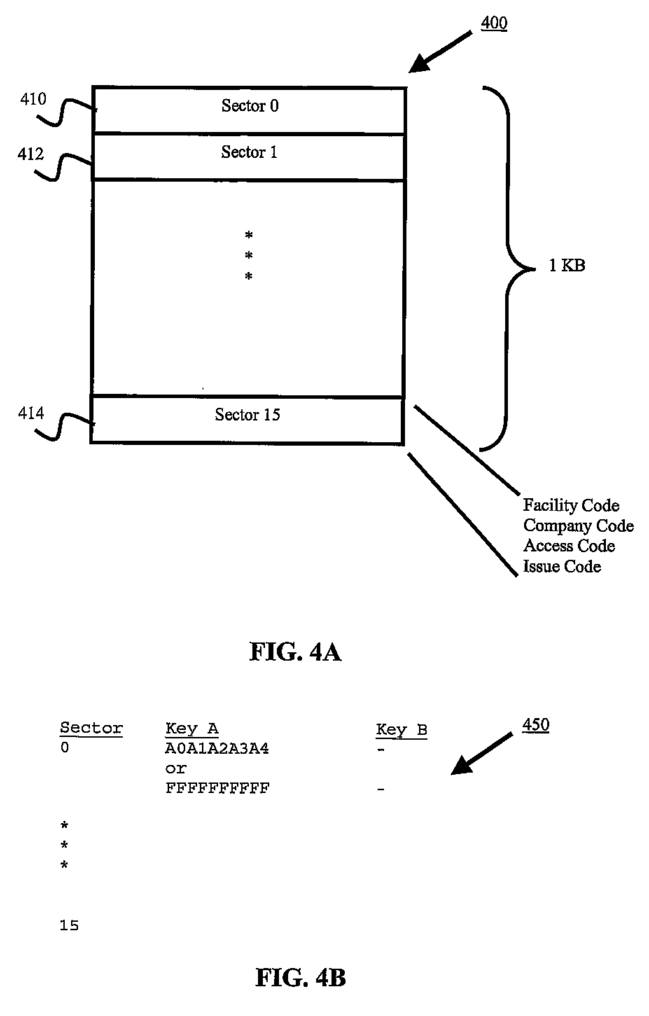

The smartcard 540 is adapted to store a digital representation of the biometric data. Preferably, the smartcard is a Mifare® smartcard for use with the contactless Mifare® reader. The smartcard 540 has approximately 1 Kbyte of storage or memory. FIG. 4A is a block diagram illustrating the structure of the storage 400 in the Mifare® smartcard, which is organised into 16 separate sectors 410-414-0 sector 410, 1 sector 412, . . . , 15 sector 414. Each of the sectors 410-414 has two keys, Key A and Key B as shown in FIG. 4B. These keys can be designated as read and read/write keys. The keys A and B for each sector are initialised by the manufacturer (e.g. 10 hexadecimal characters each) and can be changed when the sectors are written to contain biometric data in accordance with the embodiment of the invention. Each Mifare® smartcard 540 also has a unique serial number or identifier. Preferably, the 15^{th} sector 414 contains one or more of the following security parameters for use in the system of FIG. 5: a facility code, a company code, an access code, and an issue code. The facility code can identify a facility that the smartcard permits access to for a given entity or company, which is identified by the company code. The issue code identifies how many smartcards have been issued to a person. For example, if the issue code is 3, the system may hotlist corresponding smartcards for the person with issue codes of 1 or 2.

Dependent upon the format of the digital biometric data, the smartcard 540 stores such data across two or more sectors with corresponding keys for each sector of data. In the preferred embodiment, 5 to 6 sectors are used to store a digital fingerprint representation or template. For example, an ST sensor and an Yuean PCB produce a digital fingerprint representation that is approximately 320 bytes long. The length of the to representation may vary depending on the different biometric sensor products and algorithms used. As noted above, each sector needs a customer specific key to unlock the information.

Optionally, the reader 500/600 incorporates a tamper switch so that if a reader is pulled from a wall, the reader does not function and an alarm flag is activated.

As described in greater detail below, use of the biometrics smartcard encoder 500 enables authorised persons using a properly enrolled smartcard to access to a secure location or equipment, for example. Lost or stolen smartcards 540 are unusable as the person with the lost or stolen smartcard 540 does not have the correct biometrics data (e.g., fingerprint) to match that stored on the Harvard 540. Still further, another advantage of this embodiment is that the biometric smartcard reader 500 of FIG. 5 obviates the need for a central database or repository of biometric data, since the biometrics data is stored on the smartcard 540.

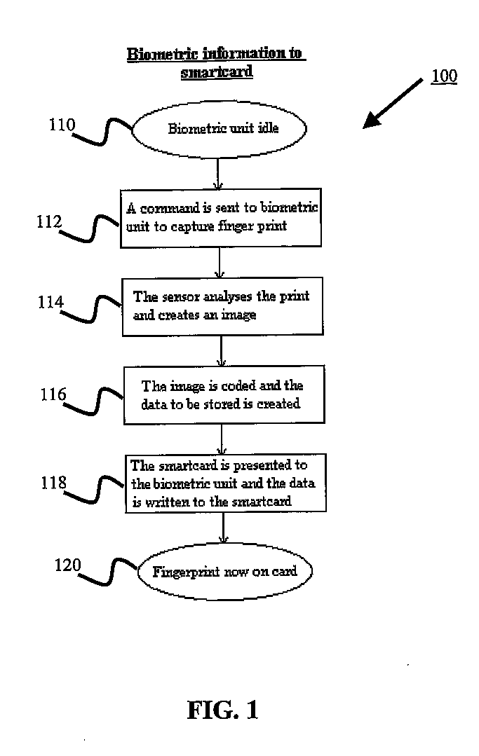

In combination with a computer (not shown), a biometrics smartcard encoder 500 can also be used to enroll a person's fingerprint on a smartcard 540. The biometrics smartcard encoder 500 uses an RS232 or USB communications port, in conjunction with software, to enroll the person's fingerprint onto the smartcard 540. Generally, software or a computer program(s) running on the computer in combination with the biometrics smartcard encoder 500 obtains personal details for a person, scans and records a fingerprint for the person, and then writes the personal details and fingerprint representation to the smartcard 540. Preferably, this embodiment does not permit fingerprint information to travel to the computer. Instead, the biometric smartcard encoder 500 stores the information and writes the information directly to the smartcard 540. The information is then erased from the memory of the biometric smartcard encoder 500. When enrolling a person's fingerprint, the detail level for scanning by the biometric smartcard encoder 500 can be changed to enable persons with scarred hands or other aberrations to use the encoder 500. This process is set fort in greater detail with reference to FIG. 1.

FIG. 1 is a high-level flow diagram illustrating details of a process 100 of obtaining and storing biometric information in a smartcard 540 using the biometric smartcard encoder (i.e., biometric unit) 500/600. In state 110, the biometric smartcard encoder 500 is initially idle. In step 112, a command is sent to the biometric smartcard encoder 500 to capture a person's fingerprint. This is preferably done by the computer using a communications port. In step 114, the sensor 5101610 of the biometric smartcard encoder 500 captures a fingerprint image. The sensor 510/610 analyses the scanned fingerprint and creates an image. In step 116, the image is coded and the data to be stored is created. This is preferably done by the sensor PCB 520 in combination with the sensor 510. In step 118, the smartcard 540 is presented to the smartcard reader PCB 530, and the biometric data from the sensor PCB 520 is written into the smartcard 540 by the smartcard reader PCB 530. State 120 at the end of the process 100 shows that the digital fingerprint representation is stored on the smartcard 540. This smartcard 540 can then be used as a security key in relation to a biometric security system.

Generally, when verification or access is required using a biometric smartcard reader 500/600, the smartcard 540 is presented to the biometric smartcard reader 500/600 and the fingerprint information is read off the smartcard 540 by the biometric smartcard reader 500/600. The person then presents their finger to the sensor 510/610 of the biometric smartcard reader 500/600 for scanning. The fingerprint representation read off the smartcard 540 is compared by the biometric smartcard reader 500/600 with the fingerprint currently obtained using the sensor 510/610. If there is a match within the detail level set at enrolment, the biometric smartcard reader 500/600 checks access privileges using the access code from the smartcard 540 and if the holder has appropriate access privileges, access is granted by the biometric smartcard reader 500/600 to the smartcard holder. Verification is strongly dependent on enrolment. A score of 100 applies for a high quality and content template. A medium threshold level may look for a score of 60, for example. The threshold level may be varied to adjust quality and content of a template.

### Details of Enrolment Process

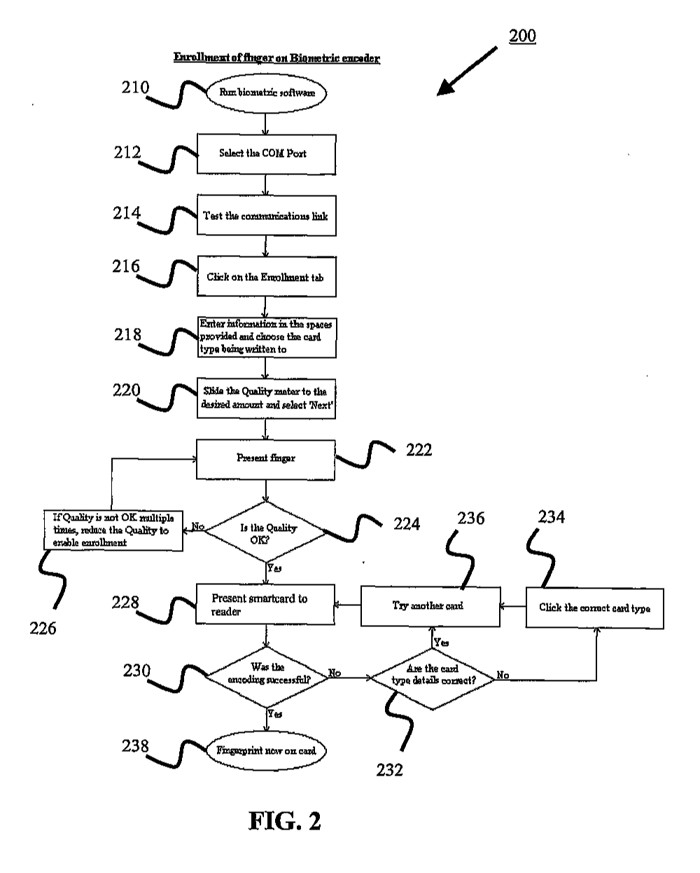

FIG. 2 is a more detailed flow diagram of a process 200 of enrolling a fingerprint using a biometric smartcard encoder, based on FIG. 1. In an initial state 210, a biometric software application is run or launched. As noted above, this software is ran on a computer connected to a biometric smartcard encoder 500/600, preferably using a RS232 or USB communications port. In step 212, a relevant RS232 or USB port (denoted generally by COM in FIG. 2) is selected by the software. Other interfaces may be practiced without departing from the scope and spirit of the invention. In step 214, the communications link (COM port) is tested to ensure the communications link is operating properly. Communication between the smartcard reader PCB 530 and the computer is preferably triple DES or Skipjack encrypted. Therefore, the information sent for access to the computer is highly difficult to compromise. In step 216, enrolment of a person's fingerprint is commenced. Preferably, this is done by clicking on an enrolment tab in the software application to commence enrolment processing. In step 218, personal details of the person whose fingerprint is to be enrolled are obtained and the type of smartcard being written to is specified. The relevant information may include one or more of the person's name, facility code, company code, access code, and issue code. Alternatively, the smartcard may be pre-encoded with some or all of this information.

In step 220, the desired detail level of the fingerprint is specified using the software application. In particular, this is done using a quality meter in the software where the detail level for the sensor 510 and PCB 520 is specified. Ordinarily, the quality is set as high as possible to avoid misreads. However, the quality can be adjusted downwardly to avoid or reduce the effects of scar tissue and other aberrations on the person's finger. In step 222, the person's fingerprint is presented to the sensor 510/610 of the biometric smartcard encoder 500/600, and the person's fingerprint is scanned. The data stream for the scanned fingerprint is sent from the sensor 510/610 to the sensor PCB 520. The information is then coded with the specific algorithm within the sensor PCB 520. The coded information is then sent to the smartcard reader PCB 530 and from there encoded onto the smartcard 540.

In decision block 224, a check is made to determine if the quality of the scanned fingerprint image from the sensor 510/610 is adequate. The sensor 510 and PCB 520 determines quality. The biometric smartcard encoder 500/600 indicates this to the computer, since the fingerprint is preferably not transferred to the computer. If the quality is inadequate (NO), the quality is reduced to eagle enrollment in step 226 and processing continues at step 222. This may occur multiple times. If decision block 224 determines that the quality is adequate (YES), processing continues at step 228.

In step 228, a smartcard 540 is presented to the smartcard reader PCB 530 of the biometric smartcard encoder 500/600. Presentation of the smartcard 540 to the smartcard reader PCB 530 results in the encoded fingerprint template and related keys for each sector being downloaded onto the smartcard 540. The communication between the smartcard 540 and the reader PCB 530 is encrypted. As noted above, the encrypted, encoded fingerprint representation is normally stored across several sectors in the storage of the smartcard. Also personal details and other information may be stored on the smartcard 540. In step 230, a check is made to determine if the encoding of the smartcard 540 was successful. If decision block 230 returns true (YES), the fingerprint template has been encoded successfully on the smartcard 540 using the encoder 500. If decision block 230 returns false (NO), processing continues at decision block 232. In decision block 232, a check is made to determine if the smartcard type details are correct. For example, the smartcard 540 may be a new or used smartcard A new smartcard has default values in its storage, while a used smartcard has changed keys A and B for example. Further, or alternatively, a different type of smartcard may be used, for example, from different manufacturers. If decision block 232 returns false (NO) indicating the card type details are incorrect, processing continues at step 234 and the correct smartcard type must be specified to the software. Processing then continues at step 236. If decision block 232 returns true (YES), processing continues at step 236. In step 236, another smartcard is tried or obtained for presentation instead of the smartcard previously presented to the smartcard reader PCB 530 of the encoder 500/600. Processing then continues at step 228.

### Details of Verification Process

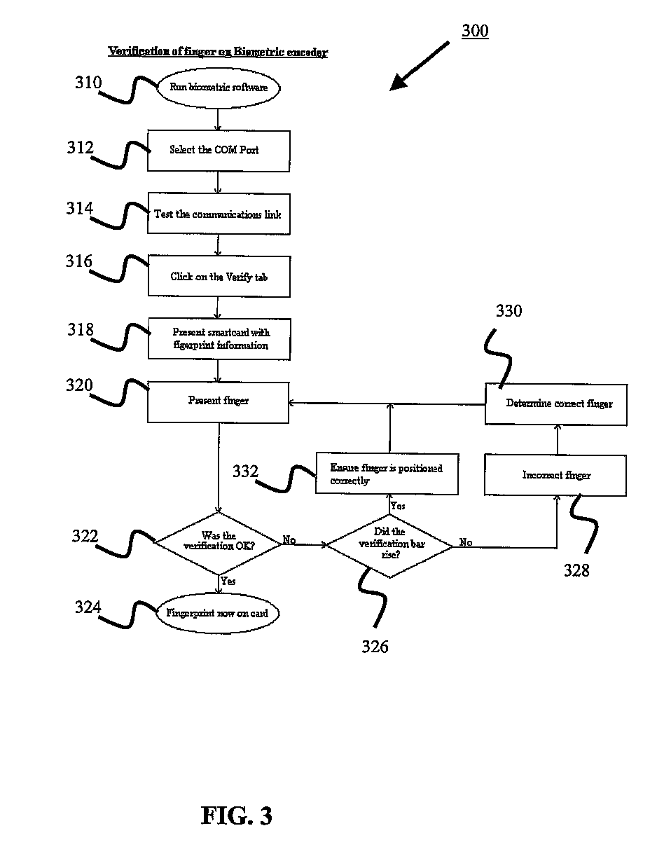

After a fingerprint representation and associated information are enrolled on a smartcard 540, verification of the enrolment on the smartcard 540 may be required. FIG. 3 is a flow diagram illustrating a process 300 of verifying a fingerprint scanned by the biometric smartcard encoder 500/600 and enrolled on the smartcard 540. In state 310, the biometric application software is loaded. In step 312, the communications link (COM port or USB) between the computer and the biometric smartcard encoder 500 is selected. In step 314, the communications link is tested to ensure the link is operating properly. In step 316, a verification application module in the software is activated. Preferably, this is done by clicking on a verify tab in the biometric application software. In step 318, the smartcard 540 with enrolled fingerprint information is presented to the encoder 500/600, which reads and stores the fingerprint information from the smartcard 540. In step 320, the person's finger is presented to sensor 510/610 of the biometric smartcard encoder 500, and the person's fingerprint is scanned and stored. The biometric smartcard encoder 500 then compares in the smartcard reader PCB 530 the scanned fingerprint template from the sensor 510/610 and the uploaded fingerprint template from the smartcard 540.

In decision block 322, a check is made to determine if the verification passed (OK). The encoder 500/600 provides the comparison result to the computer to establish verification. If decision block 322 returns true (ES), processing continues at state 324 and the fingerprint on the smartcard is verified as that of the fingerprint obtained at the sensor 510/610. Otherwise, if decision block 322 returns false (O), processing continues at step 326. In step 326, a check is made to determine if the verification bar in the software was raise. Preferably, a quality bar and a verification bar showing current levels are depicted graphically to an operator of the application software on opposite sides of a graphical image of a fingerprint icon, which indicates to the operator when a fingerprint has been properly scanned by the encoder 500/600. Raising the verification bar indicates a better match between the scanned fingerprint and the one from the smartcard 540. Verification is dependent on the quality level at enrolment. If decision block 326 returns true (YES), processing continues at step 332 and the finger must be positioned correctly for verification, before processing continues at step 320. Otherwise, if decision block 326 returns false (NO), processing continues at step 328. A determination is made that the incorrect finger has been used in relation to the recorded fingerprint information on the smartcard. In step 330, the correct finger is determined before proceeding to step 320.

### Secure Transmission System

In a security system, a smartcard reader may be setup to give access on a per door basis or to equipment. The smartcard has unique keys t must also be contained in a Smartcard reader's firmware. The smartcard reader communicates with the smartcard and information is read from the smartcard for access. The smartcard reader ordinarily communicates with an access controller, and this controller controls access; for example is the controller may preferably activate a door latch for access. Information is sent to the controller. Communication between the smartcard reader and the controller is usually Wiegand. However, the communications may be RS485 or RS232. Still further, another example of a common form of communication back to a controller is Clock and Data. These formats can be cracked or defeated given time, as formats are usually ‘known’ industry standards. The controller determines whether or not to grant access and activates an access mechanism if granted. When using a security access reader to grant or deny access, a possible breach in security lies in the information that is directly sent to the controller by the smartcard reader. If the smartcard reader is removed from a wall or other connection point and a signal is introduced to the line between the smartcard reader and the controller, then a security breach exists. The signal may provide information to the controller so that the controller improperly grants access. If the smartcard reader has a tamper switch, a degree of added security is provided. A hole in the wall may still be made conditional to the material of the wall, and a security breach may still occur, as this enables access to the cables of the reader. In contrast, a stand-alone reader does not need a controller so this does not apply to such a reader.

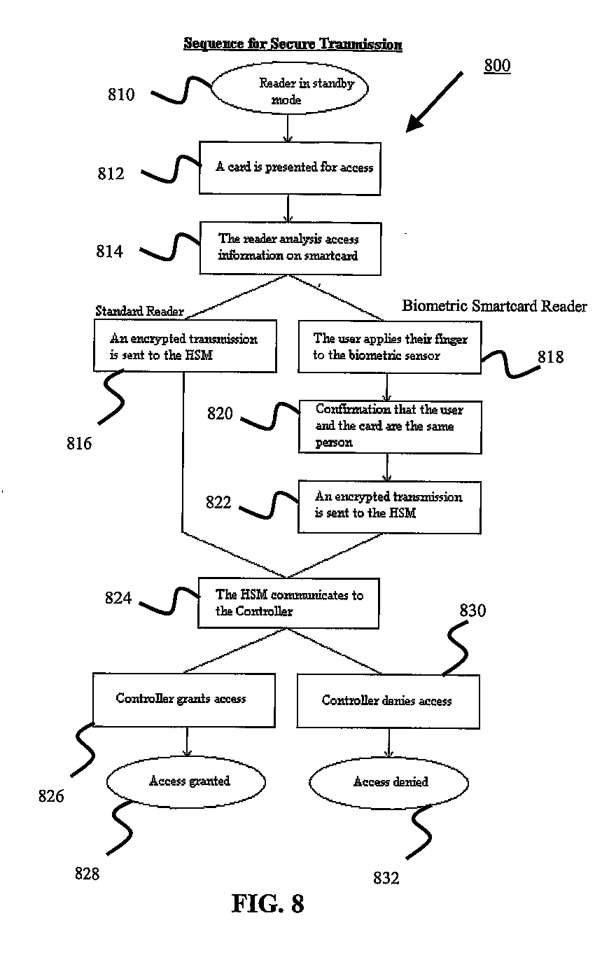

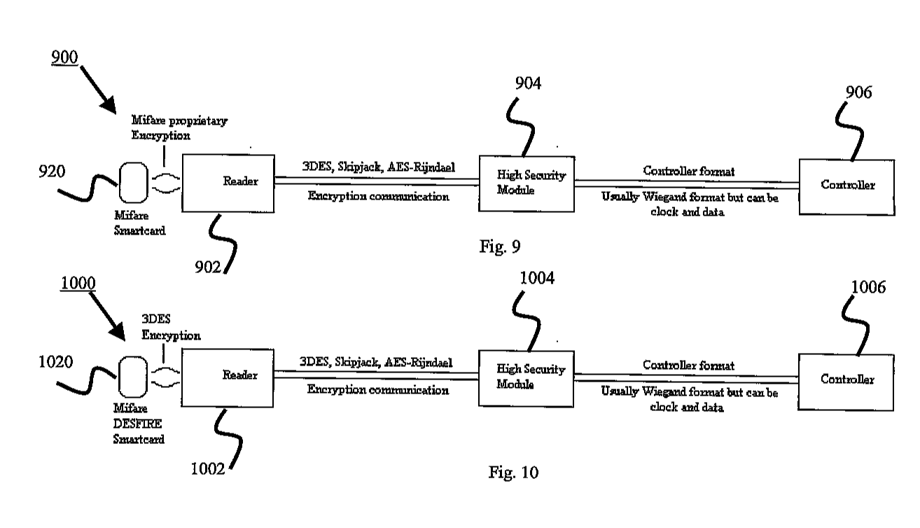

In accordance with a further embodiment of the invention, secure transmission from a smartcard reader is provided by encrypting the messages from the smartcard reader in the security system. Preferably, the smartcard reader is a biometrics smartcard reader 500/600, but ordinary smartcard readers may be practiced. The further embodiment of the invention shown in FIGS. 7 and 8 addresses this issue. This applies to the embodiments of FIGS. 9-11 as well.

FIG. 7 is a block diagram of a secure transmission system 700 in accordance with the further embodiment of the invention. A smartcard reader 702 is coupled to a high security module (HSM) 704. Preferably, the smartcard reader 702 is a biometrics smartcard reader 500/600, but may be a standard smartcard reader. The HSM 704 is located remotely from the smartcard reader 702 and preferably at an inaccessible location relative to the smartcard reader 702, for example on the other side of a wall in a secure area. The distance between the smartcard reader 702 and the HSM 704 may be up to 15 metres. Communications between the reader 702 and the HSM 704 are preferably Triple DES or Skipjack encrypted, but other encryption techniques may be employed. The HSM 704 is in turn coupled to a controller 706. Communications between the HSM 704 and the controller 706 are carried out using the controller-specified format, which is usually Wiegand format but may be another format (e.g., clock and data). In turn the controller 706 is connected to the door latch 708 to control operation of the door for access. Different access mechanisms may be used in place of a door latch 708, for example to provide access to a computer.

Significantly, the system 700 uses an HSM 704 for each access point and encrypted communications between the smartcard reader 702 and the HSM 704. The smartcard reader 702 preferably reads the information off a smartcard and communicates with the HSM 704 on the secure side of the wall, up to 15 metres away. Again, the communication is encrypted, preferably using a 3DES or Skipjack encrypted protocol. The HSM 704 decrypts the message to obtain the security information from the smartcard, e.g. “Facility Code” and the “Access number”, and communicates these values to the access controller 706. Thus, communication between the smartcard reader 702 and the HSM 704 and thus the controller 706 is secure whether the smartcard reader 702 is removed from the wall or wiring is accessed through a wall. This provides a higher standard of security for access control systems.

FIG. 8 is a flow diagram illustrating a process 800 for secure transmission. In state 810, the smartcard reader 702 is in standby mode. In step 812, a smartcard is presented for access. In step 814, the smartcard reader 702 reads and analyses access information on the smartcard. The smartcard and the reader must have the same keys. If a standard smartcard reader is used, an encrypted transmission is sent to the HSM 704 in step 816. Processing then continues at step 824. Otherwise, if a biometric smartcard reader 500/600 is used, after step 814, processing continues at step 818. In step 818, biometric data is obtained from the cardholder using the biometric sensor of the biometric smartcard reader 500/600 as reader 702. Preferably, the biometric data is fingerprint information. In step 820, the biometric data of the cardholder and the stored biometric data from the smartcard are compared and confirmed to be the same person or not. If the biometric data matches, in step 822, an encrypted transmission for access is sent to the HSM 704 from smartcard reader 702, before processing continues at step 824. In step 824, the HSM 704 decrypts the transmission and communicates it to the controller 706 using the appropriate controller format, e.g. Wiegand. The controller 706 either grants access 828 in step 826 or denies access 832 in step 830 dependent upon the access rights obtained from the smartcard.

### Further Embodiments of Secure Transmission System

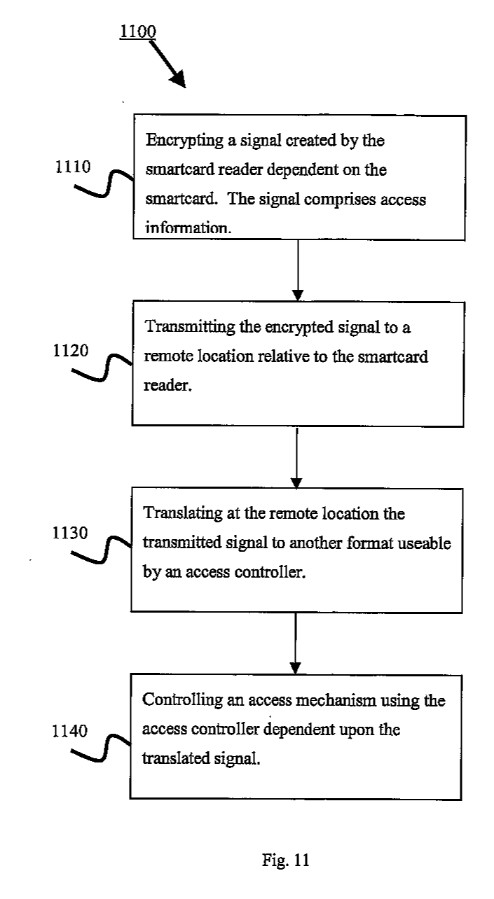

FIG. 11 is a flow diagram illustrating a method 1100 of providing secure transmissions from a smartcard reader in accordance with an embodiment of the invention. In step 1110, a signal created by the smartcard reader dependent on the smartcard is encrypted. The signal comprises access information. In step 1120, the encrypted signal is transmitted to a remote location relative to the smartcard reader. In step 1130, the transmitted signal is translated at a remote location to another format useable by an access controller. In step 1140, an access mechanism is controlled using the access controller dependent upon the translated signal. The smartcard may contain biometric data and the smartcard reader may comprise a biometric smartcard reader for obtaining biometric data directly. The biometric data may comprise fingerprint data. The biometric data is not transmitted to the remote location from the smartcard reader.

FIGS. 9 and 10 are block diagrams of secure transmission systems in accordance with further embodiments of the invention. In these drawings, modules with similar functionality to those of the modules shown in FIG. 7 are indicated with corresponding reference numbers, except that the leading digit(s) is replaced to correspond with the Figure number (e.g., the access controller 906 of FIG. 9 corresponds to the access controller 706 of FIG. 7). For the sake of brevity only, aspects of the smartcard reader and security system are not repeated hereinafter, but reference is made to the description accompanying FIGS. 7 and 8. Further, the door latch shown in FIG. 7 (and identified by reference numeral 708) is not depicted in each of FIGS. 9 and 10, only to simplify those drawings. However, it is to be understood that such an access mechanism is or can be coupled to each of the controllers 906 and 1006 of FIGS. 9 and 10, respectively.

Again, in a security system 900 or 1000, a smartcard reader may be setup to give access on a per door basis or to equipment. In general, the smartcard reader communicates with the smartcard and information is read from the smartcard for access, information is sent to the controller, and the controller determines whether or not to grant access and activates an access mechanism if granted. Secure transmission from a Smartcard reader is provided by encrypting the messages from the smartcard reader in the security system. Preferably, the smartcard reader is a biometrics smartcard reader 500/600, but ordinary smartcard readers may be practiced.

The system 900 of FIG. 9 comprises a smartcard reader 902, a-high security module (HSM) 904, and an access controller 906. While not shown in FIG. 9 to simplify the drawing, the controller 906 may be coupled to an access mechanism able to provide access (e.g., to a door, portal, computer, network, or other secure equipment or installation) at an access point. Preferably, the smartcard reader is a biometrics smartcard reader 500/600, but ordinary smartcard readers may be practiced. The smartcard reader may be a Banque-Tec International reader.

A smartcard 920 (e.g., a Mifare smartcard) is presented to the smartcard reader 902, and the smartcard reader 902 communicates with the smartcard. Preferably, communications between the Mifare smartcard 920 and the smartcard reader 902 are encrypted using Mifare proprietary encryption. However, other forms of encryption may be practiced without departing from the scope and spirit of the invention. The description accompanying FIG. 10 provides examples of other encryption techniques that may be practiced. Also, the smartcard 920 preferably includes biometrics data, as described hereinbefore. The reader 902 reads access information from the smartcard 920. The access information may include one or more of the following: person's name, facility code, company code, access code, and issue code. Other access information and/or authorisation data may be sent from the smartcard reader 902 to the HSM 904 using suitable communications protocols, such as RS232 or RS485. Other communications protocols may be practiced without departing from the scope and spirit of the invention.

The HSM 904 is located remotely from the smartcard reader 902 and preferably at an inaccessible location relative to the smartcard reader 902. Communications between the reader 902 and the HSM 904 are encrypted. The encryption technique used may use one or more of the following techniques: Triple DES (3DES), Skipjack, and AES-Rijndael. Other encryption techniques may be practiced without departing from the scope and spirit of the invention. The distance between the smartcard reader 902 and the HSM 904 may be up to at least 1.2 kilometres, e.g. if RS485 is used. The distance between the smartcard reader 902 and the HSM 904 may be varied dependent on the communications protocol, techniques, and media used.

The HSM 904 is in turn coupled to a controller 906. Communications between the HSM 904 and the controller 906 are carried out using the controller-specified format, which is usually Wiegand format but may be another format (e.g., clock and data). The distance between the HSM 904 and the controller 906 may be up to 500 feet. However, this distance may be varied without departing from the scope and spirit of the invention. In turn, the controller 906 may be connected to an access point (e.g., the door latch 708 of FIG. 7) to control operation of the access point. Different access mechanisms may be used.

The HSM 904 translates the encrypted signal to another format for a controller and communicates the translated signal to the access controller 906. The translation preferably involves decrypting the message to obtain the security or access information from the smartcard, e.g. “Facility Code” and the “Access number” and communicating the values to the access controller. Thus, communications between the smartcard reader 902 and the HSM 904 and thus the controller 906 is secure whether the smartcard reader 902 is removed from the wall or wiring is accessed through a wall. This provides a higher standard of security for access control systems. The process of FIG. 8 applies to this embodiment.

The system 1000 of FIG. 10 comprises a smartcard reader 1002, a high security module (HSM) 1004, and an access controller 1006. While not shown in FIG. 10 to simplify the drawing, the controller 1006 may be coupled to an access mechanism (e.g., to a door, portal, computer, network, or other secure equipment or installation) at an access point. Preferably, the smartcard reader is a biometrics smartcard reader 500/600, but ordinary smartcard readers may be practiced. The smartcard reader may be a Banque-Tec International reader. The system of FIG. 10 is largely identical to that of FIG. 9 and therefore the following description is limited to identifying the points of difference for the sake of brevity.

A smartcard 1020 (e.g., a DESFIRE Mifare smartcard) is presented to the smartcard reader 1002, and the smartcard reader 1002 communicates with the smartcard. Preferably, communications between the Mifare smartcard 1020 and the smartcard reader 1002 are encrypted using triple DES (3DES) encryption. However, other forms of encryption may be practiced without departing from the scope and spirit of the invention. The remainder of the system 1000 is the same as that for the system 900 of FIG. 9, and is not repeated for the sake of brevity. The process of FIG. 8 applies to this embodiment.

A small number of embodiments of the invention regarding methods, devices, and systems for biometric smartcard reading and encoding, as well as for secure transmissions have been described. In the light of the foregoing, it will be apparent to those skilled in the art in the light of this disclosure that various modifications may be made without departing from the scope and spirit of the invention.

1-31. (canceled)

32. A method of providing secure transmissions from a biometric smartcard reader, said method comprising the steps of:
encrypting a signal created by said biometric smartcard reader dependent on a smartcard containing biometric data, said smartcard reader able to obtain biometric data directly, said signal comprising access information dependent upon biometric data obtained directly by said biometric smartcard reader from a user and said biometric data contained in said smartcard;
transmitting said encrypted signal to a high security module at a remote location relative to said biometric smartcard reader;
translating by said high security module at said remote location said transmitted signal to another format useable by an access controller; and
controlling an access mechanism using said access controller dependent upon said translated signal.

33. The method according to claim 32 wherein said biometric data comprises fingerprint data.

34. The method according to claim 32 wherein said biometric data is not transmitted to said high security module at said remote location from said smartcard reader.

35. The method according to claim 32 further comprising the step of providing access using said access mechanism if said translated signal is determined by said access controller to authorize access.

36. The method according to claim 35, wherein said access mechanism is able to provide access to at least one of a door, portal, computer, network, secure equipment and secure installation.

37. The method according to claim 32 wherein said access information comprises at least one of a person's name, a facility code, a company code, an access code, and an issue code.

38. The method according to claim 32 wherein said signal is encrypted using triple DES, Skipjack, or AES Rijndael encryption.

39. The method according to claim 32 further comprising the step of encrypting communications between said biometric smartcard and said biometric smartcard reader.

40. The method according to claim 39 wherein said high security module translates said encrypted signal to said other format.

41. The method according to claim 39 wherein said biometric smartcard reader and said high security module are separated by a distance of up to 1.2 kilometers.

42. The method according to claim 39 wherein said biometric smartcard reader and said high security module are separated by a distance of up to 15 meters.

43. The method according to claim 32 wherein said translated signal is in a controller-specified format.

44. The method according to claim 43 wherein said controller-specified format is Wiegand format, or clock and data.

45. A system for providing secure transmissions from a biometric smartcard reader, said system comprising:
a biometric smartcard reader for encrypting a signal created by said biometric smartcard reader dependent on said smartcard containing biometric data, said smartcard reader able to obtain biometric data directly, said signal comprising access information dependent upon biometric data obtained directly by said biometric smartcard reader from a user and said biometric data contained in said smartcard, and for transmitting said encrypted signal using a communications protocol to a remote location relative to said biometric smartcard reader;
a high security module for receiving said transmitted signal and translating said transmitted signal to another format useable by an access controller; and
an access controller for controlling an access mechanism using said access controller dependent upon said translated signal.

46. The system according to claim 45 wherein said biometric data comprise fingerprint data.

47. The system according to claim 45 wherein said biometric data is not transmitted to said high security module from said biometric smartcard reader.

48. The system according to claim 45 further comprising an access mechanism providing access if said translated signal is determined by said access controller to authorize access.

49. The system according to claim 48 wherein said access mechanism is able to provide access to at least one of a door, portal, computer, network, secure equipment and secure installation.

50. The system according to claim 45 wherein said access information comprises at least one of a person's name, a facility code, a company code, an access code, and an issue code.

51. The system according to claim 45 wherein said signal is encrypted using triple DES, Skipjack, or AES Rijndael encryption.

52. The system according to claim 45 wherein communications between said biometric smartcard and said biometric smartcard reader are encrypted.

53. The system according to claim 52 wherein said biometric smartcard reader and said high security module are separated by a distance of up to 1.2 kilometers.

54. The system according to claim 52 wherein said biometric smartcard reader and said high security module are separated by a distance of up to 15 meters.

55. The system according to claim 45 wherein said translated signal is in a controller-specified format.

56. The system according to claim 55 wherein said controller-specified format is Wiegand format, or clock and data.

57. The system as claimed in claim 45 wherein said encrypted signal is transmitted using a communications protocol and said high security module decrypts said transmitted signal, said communications protocol being different from said format useable by said access controller.

58. The system as claimed in claim 57 wherein said transmitted signal is transmitted using one of RS-232 and RS-485 communications protocol.
